(19) United States
(12) Patent Application Publication
(10) Pub. No.: US 2009/0178982 A1
(43) Pub. Date: Jul. 16, 2009

(54) CARTRIDGE FILTER CLEANING METHOD AND APPARATUS

(75) Inventor: AARON K. BASTEN, SOLON, IA (US)

Correspondence Address: MCKEE, VOORHEES & SEASE, P.L.C., 801 GRAND AVENUE, SUITE 3200, DES MOINES, IA, 50309-2721, US

(73) Assignee: VECTOR CORPORATION, Marion, IA (US)

(21) Appl. No.: 11/972,995

(22) Filed: Jan. 11, 2008

(51) Int. Cl. B01D 29/00; B01D 24/46

(52) U.S. Cl. 210/791; 210/350

(57) ABSTRACT

An improved cleaning apparatus and method is provided for cartridge filters in a fluid bed processor. A cleaning solution duct is coupled to the air pulse tube so as to supply a mixture of pressurized air and cleaning liquid to the inside of the filter cartridge. The pressure forces the cleaning solution and air outwardly through the filter cloth to remove particles from the interstitial pores of the cloth. The cleaning liquid also flushes the interior and the exterior surface of the cloth. The lower end of the filter includes a cap which is normally closed, and which can be opened to allow drainage of cleaning liquid from the interior of the cartridge filter.

### BACKGROUND OF THE INVENTION

Fluidized bed processes are commonly used for powder drying, coating and granulation of particulate material, such as pharmaceuticals and seeds. The processor generally includes a vessel defining a chamber through which the particles move during processing. The chamber includes one or more filters to prevent fluidized powder and fines from escaping the vessel. Pleated cartridge filters allow the powder to collect on the outside of the filter cloth. The powder or the outside of the filter may be returned to the product bed by back pulsing a high velocity stream of air into a center of the cylindrical cartridge filter through an open discharge end of the filter, with air being forced in a reverse direction through the filter cloth from the inside to the outside, thereby partially cleaning the filter cloth. Such air pulsing is accomplished with an extremely fast acting and large ported air valve. This air pulsing cleaning method is a short term solution, since it does not clean the filters well enough for permanent running of a given product. Over time, the filters will blind or clog on most products. Also, the filters will not be clean enough to run a different product without additional cleaning in order to prevent cross-contamination of products.

Some particles penetrate the filter cloth into the inside of the filter, becoming trapped in the interstitial pores of the filter cloth, and cannot be forced back through the filter by the air pulse. Eventually, the filters become blinded by the entrapped particles, thereby creating an unacceptable pressure drop created by the air flow through the filter cloth. Then, the filters must be thoroughly cleaned, which normally require the filter to be removed from the vessel of the processor.

Attempts have been made to clean the blinded filters in place, without removal from the processor, by spraying cleaning solutions onto the inside and outside filter surfaces using low pressure spray nozzles. However, this cleaning technique is deficient in that powder particulate remains trapped in the interstitial pores, or gets forced into the interior of the cartridge from the outside spray nozzle. Powder on the inside of the filter is highly unlikely to be forced outwardly through the filter cloth by low pressure spray nozzles. Thus, even though the filter may pass an external surface swab test, the powder material may still be present in the filter pores. This entrapped powder may migrate out of the filter during subsequent processing of particulate material in the fluidized bed, and thereby contaminate the process batch.

Another cleaning method involves lowering of the filters into a bath of cleaning solution in the bottom of the processor, and agitating the filters in the bath, similar to a laundry washing machine. This wash method of cleaning the filters, as well as the spray nozzle methods of cleaning, require large volumes of cleaning solution which must be disposed in accordance with environmental standards and regulations.

In a pharmaceutical fluidized bed processor, various cleaning liquids and protocols are used for cleaning the filters. Some products are soluble with water, soluble with solvents, or insoluble. Some products require solvent, surfactant, acid or basic solutions for removal from the filter. Most protocols include a clean or de-ionized water rinse after the filter cleaning wash.

The geometry of pleated filters also creates narrow crevices at many angles to a cleaning spray nozzle. The angled crevices limit the ability to get direct contact from the sprayed cleaning solution, and thus limit the effectiveness of the spray nozzle. Some fluidized bed processors have replaced the pleated cartridge filter with a simple cylindrical cartridge filter. However, a cylindrical filter has substantially less surface area than a pleated filter, and thus requires more filter cartridges and/or longer cylindrical filters. Furthermore, cylindrical filters are not as durable, as compared to a pleated filter. Therefore, the filter cloth has been strengthened by providing multiple sintered layers of fine mesh stainless steel screen, which also present cleaning difficulties due to the multiple layers.

Therefore, a primary objective of the present invention is the provision of an improved method for cleaning pleated cartridge filters in a fluidized bed processor.

Another objective of the present invention is the provision of an improved apparatus for cleaning pleated filter cartridges in place in a fluidized bed processor.

A further objective of the present invention is the provision of an inline filter cleaning process for a fluidized bed processor.

Still another objective of the present invention is the provision of a filter cleaning process which utilizes a combination of pressurized air and cleaning liquid which is back pulsed through the filter for removing particles from the filter cloth.

Yet another objective of the present invention is the provision of an apparatus and method for effective and efficient cleaning of a pleated cartridge filter of a fluidized bed processor.

Another objective of the present invention is the provision of an apparatus and method for cleaning fluidized bed filters which minimizes the use of cleaning liquid.

Another objective of the present invention is the provision of an apparatus and method for cleaning the interstitial pores of a pleated cartridge filter in a fluidized bed processor.

A further objective of the present invention is the provision of an apparatus and method for cleaning fluidized bed filters which allows for easy compliance with environmental standards and regulations.

Another objective of the present invention is the provision of an apparatus and method for cleaning pleated cartridge filters economically in a fluidized bed processor.

These and other objectives will become apparent from the following description of the invention.

### BRIEF SUMMARY OF THE INVENTION

A fluid bed processor for processing particulate material is improved by adding an inlet for cleaning liquid in communication with the pressurized pulse air line. The liquid inlet is located upstream from the outlet of the air line so that a combination of air and liquid is discharged from the outlet for back pulsing through a pleated cartridge filter installed in the processor. The air and liquid cleaning mixture passes from the inside of the filter to the outside so as to remove particles from the interstitial pores of the filter cloth. The upper and lower ends of the cartridge filter are normally closed during the back pulsing process. The lower end is then opened to drain the cleaning mixture from inside the filter.

A method for cleaning the cartridge filter of the fluidized bed processor utilizes the back pulsing a mixture of air and cleaning solution through the filter at high velocities and high pressure in repeated millisecond cycles for inline cleaning of the filter cloth. The back pulsing forces particles out of the filter cloth into the processing chamber of the processor. After the back pulsing cycles, cleaning solution can also be sprayed onto the filter surfaces for rinsing the filter. A final air rinse is provided to remove the rinse solution from the filter surfaces.

### BRIEF DESCRIPTION OF THE DRAWINGS

FIG. 1 is a side elevation view of a fluidized bed processor having pleated cartridge filters mounted therein and the improved filter cleaning system of the present invention.

FIG. 2 is a perspective view from the upstream end of a pleated cartridge filter for the fluidized bed processor.

FIG. 3 is a perspective view from the downstream end of the pleated cartridge filter.

FIG. 4 is a side elevation view of the pleated cartridge filter.

FIG. 5 is an end view showing one embodiment of a cartridge filter mounted in the processing chamber of a fluidized bed processor.

FIG. 6 is a sectional view taken along lines 6-6 of FIG. 5 and show the bottom of the filter closed.

FIG. 7 is a sectional view taken along lines 7-7 of FIG. 5.

FIG. 8 is an enlarged view taken along line 8 of FIG. 6.

FIG. 9 is an enlarged view taken along line 9 of FIG. 6.

FIG. 10 is a view similar to FIG. 6 showing the cartridge filter with the bottom opened.

FIG. 11 is an enlarged view taken along line 11 of FIG. 10.

### DETAILED DESCRIPTION OF THE DRAWINGS

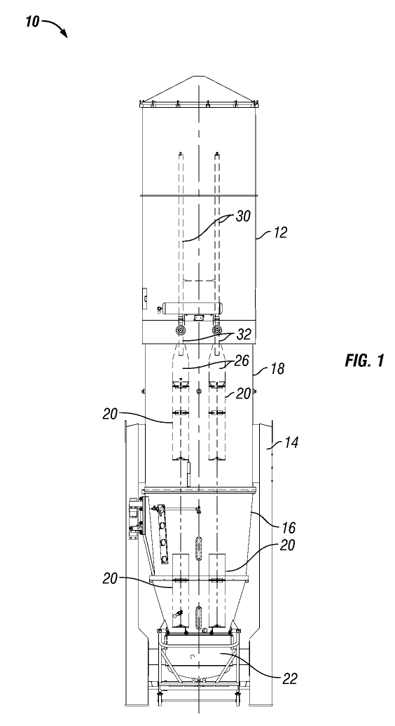

A fluidized bed processor is generally shown in FIG. 1 and designated by the reference numeral 10. The processor 10 includes a vessel 12 mounted on a frame 14 so as to be disposed in a substantially vertical orientation. The vessel 12 includes an expansion chamber 16 and a filter chamber 18. One or more filters 20 are mounted in the filter chamber 18, as described in more detail below. Preferrably, the filters 20 are a pleated cartridge, though other types of filters may be used. An air inlet plenum 22 with an inlet duct is provided at the bottom of the vessel 12. An exhaust duct 26 is provided on the vessel 12 in communication with the filter chamber 18. A drain is provided at the bottom of the processor 10.

The cartridge filters 20 are moveable within the vessel 12 between a raised position, shown in dotted lines in FIG. 1, and a lowered position, shown in solid lines. Movement of the filters 20 is controlled by cylinders 30 having extensible arms 32.

The general structure and operation of the fluid bed processor 10 is conventional, with the exception of the cartridge filters 20. The present invention is directed towards an improved apparatus and method for cleaning the filters 20 in place, while installed in the vessel 12.

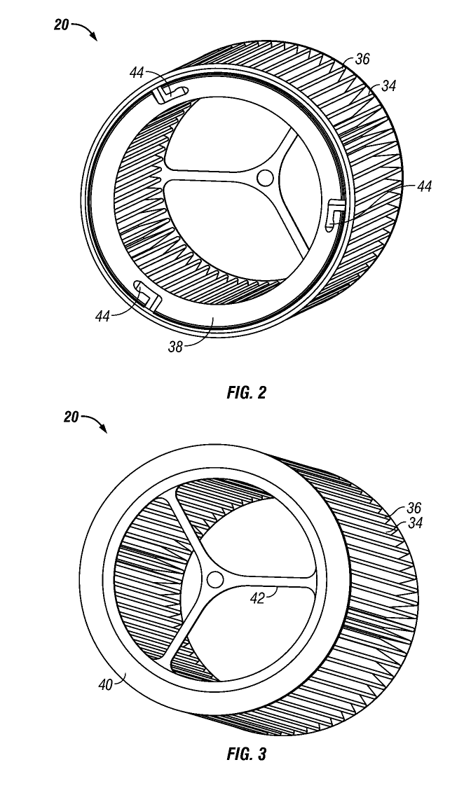

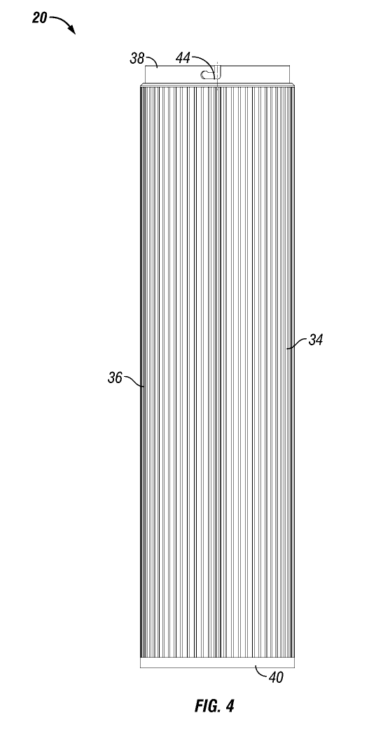

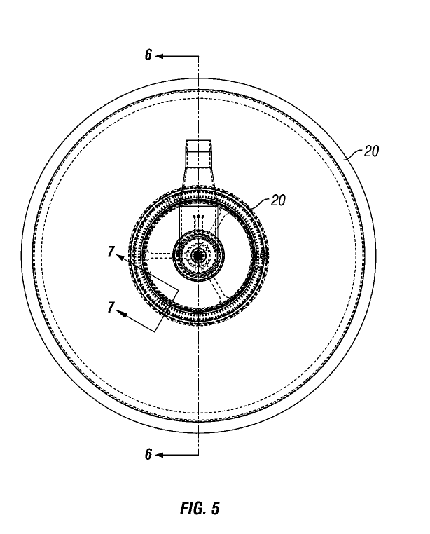

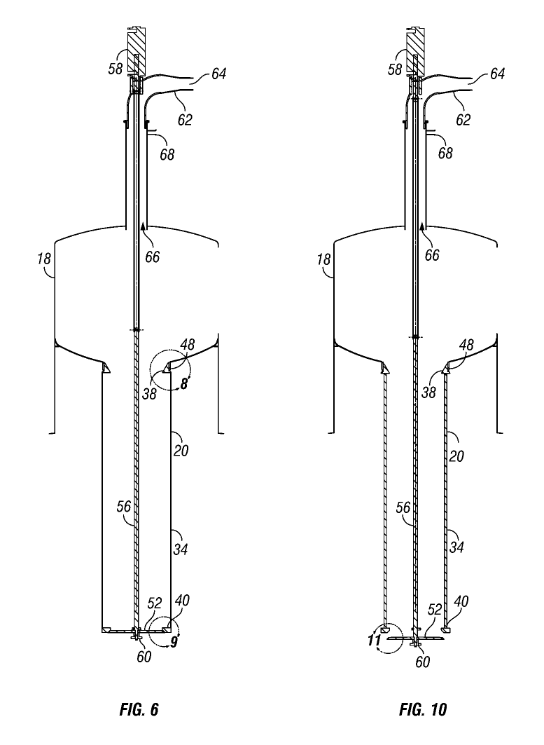

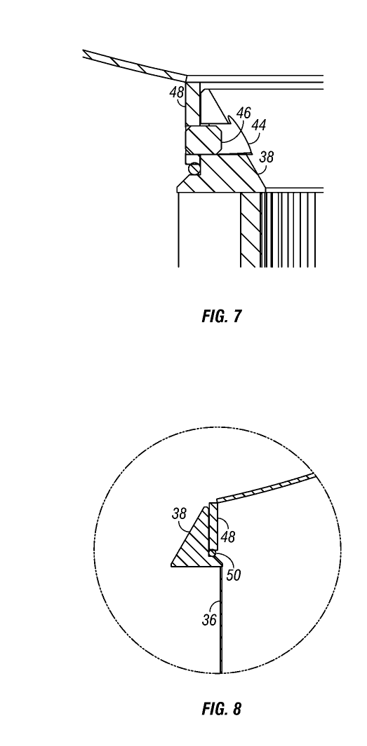

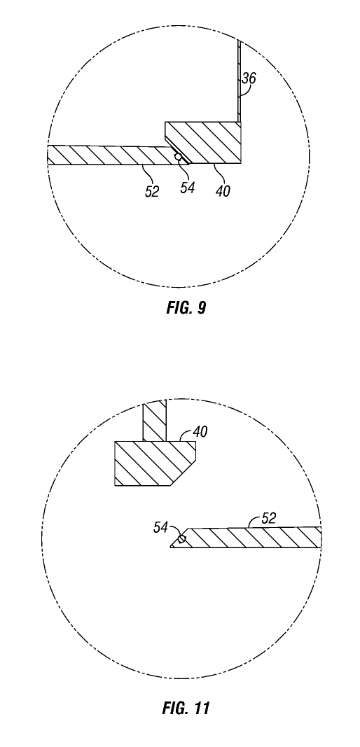

As best seen in FIGS. 2-4, each filter 20 comprises a cylindrical body 34 having a pleated filter cloth 36. The upper end of the body 34 has a circular frame 38, while the lower end of the body 34 has a circular frame 40 with a web or arms 42 extending across the lower frame 40. As seen in FIGS. 6 and 7, the upper frame 38 includes a bayonet slot 44 adapted to receive a locking pin 46 to mount the cartridge filter 20 to a support wall 48 of the filter chamber 18. The bayonet slot 44 provides a twist lock assembly to the support wall 48 via the locking pin 46. The bayonet connection allows for easy installation and replacement in the event that a filter 20 becomes damaged or otherwise unusable. However, in the normal function of the processor 10, the filters 20 are considered to be permanently installed. An O-ring seal 50 resides between the upper frame 38 and the support wall 48, as best seen in FIGS. 7 and 8.

The lower frame 40 of the filter 20 is adapted to matingly receive a sealing plate 52 which is moveable between a closed position, as shown in FIG. 6, and an open position, as shown in FIG. 10. An O-ring seal 54 resides between the lower frame 40 and the bottom plate 52. The position of the plate 52 is controlled by extension and retraction of an arm 56 of an air cylinder 58. The lower end of the arm 56 extends through the center of the web 42 of the lower frame 40 and is retained by a threaded knob 60.

It is understood that the filters 20 can be mounted by means other than the bayonet connection. Also, different seals can be used, other than the O-ring seals 50, 54. The raising and lowering of the filter plate 52 can also be achieved by means other than the cylinder 58, such as jack screws, hydraulic cylinders, winches and cables, and the like.

During normal powder processing, the plate 52 is in the raised closed position, so that processed air flowing through the processor 10 must pass through the filters 20 before exiting the vessel 12 via the exhaust duct 26.

The processor 10 includes an air pulse tube 62 having an inlet 64 connected to a source of pressurized air, and an outlet 66 leading into the filter chamber 18. A cleaning liquid duct 68 communicates with the air pulse tube 62 upstream from the outlet 66. The duct 68 is connected to a source of cleaning solution.

When the filters 20 become blinded, the processor 10 is shut down for back pulse cleaning of the filters in place, without removal of the filters 20 from the processor vessel 12. The bottom plate 52 of the filter 20 remains closed. The filters may be pre-wet or pre-washed before back pulsing. Pumps for the pressurized air source and the cleaning liquid source are actuated so as to supply pressurized air to the pulse tube 62 and cleaning solution to the duct 68. The cleaning liquid mixes with the pressurized air in the tube 62 before being discharged into the filter chamber 18 so as to flow into the interior of the filter body 34. The pressure forces the air and cleaning solution outwardly through the filter cloth 36 so as to remove particles from the interstitial pores of the cloth. The pressurized air and cleaning liquid mixture is pulsed in very short cycles. Preferably, each pulse or shot of air/cleaning solution mixture is for 0.1-0.2 milliseconds, at a pressure ranging between 20-80 psi, and a volume of 2.0-5.0 cu. ft. of air and 0.25-0.5 gallons of cleaning solution. After a predetermined number of pulse cycles, one or more spray nozzles (not shown) are actuated to rinse the inside surface of the filter chamber 18.

Initially, the back pulse with liquid is applied while the lower end plate 52 is closed to ensure the maximum amount of back pressure availability for maximum cleaning action. After a predetermined regime of pulse cycles and rinsing cycles, the lower plate or end cap 52 is lowered to open the lower end of the filter 20. Then, another predetermine regime of pulse cycles and liquid rinses can be employed to flush any remaining product out of the open end of the filter 20 as seen in FIG. 10, so as to drain cleaning solution from the interior of the filter body 34. Movement of the plate 52 to the lower or open position also exposes the O-ring seal 54 to a cleaning solution flush.

The pulse action of the air and cleaning solution through the filter cloth 36 produces a stream of solution flushing down the outside of the cloth, and thus eliminates the need for external spray nozzles to flush powder off the exterior of the filters 20. Preferably, low pressure spray nozzles are used to clean the inside surface of the vessel 12. The final step in the process, after total cleaning of the filters 20 and vessel 12, is an air pulse to blow out any remaining rinse water from the interior surface of the vessel 12 and from the filter cloth 36, before closing the bottom plate 52. This final air pulse minimizes the time required to dry the interior of the vessel 12 and the filters 20 prior to starting a production cycle in the processor 10.

When the filter 20 is back pulsed, the high velocity air stream forces the cleaning liquid through the filter cloth 36 in the reverse direction of the processing air, that is, from the inside to the outside of the cylinder body 34. The filter cloth 36 may be pre-wetted with cleaning solution, prior to the back pulse cycles. Due to the relative high density of the cleaning liquid, compared to the air, the pulse is very violent in comparison to prior art air pulsing. Also, the high density liquid coats the filter cloth surface and penetrates in interstitial pores, so as to act as a partial barrier to the pulse air, thereby creating an increased differential back pressure across the filter cloth 36 by the pulse air stream. Thus, the cleaning liquid is pushed through the filter cloth 36 with increased force.

During normal operation of the processor 10, the maximum back pulse air pressure is limited, because too much pressure will force process powder into the product container support screen or perforated plate at the bottom of the vessel 12. Due to the robust nature and strength of metal filters, and the absence of product, a much higher pulse air pressure can be used to clean the filters 20, than when processing powder. Because of the increased forces employed during the cleaning process, the solid or dissolved particles can be pushed back through the filter cloth 36 more efficiently, as compared to a low pressure, low density air pulse or low pressure liquid spray nozzles. Such increased forces derive from the high density of the cleaning liquid, the carrying force of the higher density liquid, and the potential for higher pulse air pressure.

Since the cleaning liquid insertion period is only required immediately before the pulse cycle, and the pulse cycles are only milliseconds in duration, there is a very minimal amount of cleaning solution used to pulse cycle. For example, the normal flow rate of liquid insertion may be as low as one to two gallons per minute. Thus, a total liquid insertion/pulse cycle every five seconds will only use 0.08-0.16 gallons of cleaning liquid per pulse. To ensure the filter is pre-wetted prior to pulsing, the cleaning liquid is inserted slightly before and during the pulse which will increase the liquid volume slightly. This compares to normal flow rates of low pressure cleaning nozzles of 10 to 20 gallons per minute, with many minutes per cleaning cycle. With the numerous cartridge filters required for large processors 10, coupled with 2 to 4 or more cleaning solution types required per cleaning regime and the multiple number of nozzles required to cover the inside and outside filter cloth surface, a large volume of cleaning solution is required in prior art cleaning processes. In other prior art cleaning processes wherein the filters are dipped into baths of various cleaning solutions in the bottom of the processor, large amounts of cleaning liquid are required, in direct proportion to the process's size. Thus, the present cleaning method saves substantially on the volume of cleaning liquid used during the cleaning process.

The present invention modifies the prior art air pulse system of cartridge filter processors with the addition of the cleaning liquid insertion duct 68 and liquid valve (not shown). It is understood that a pulse tube 62 and liquid duct 68 is provided for each filter 20 in the processor 10. A liquid control valve (not shown) can be used on each duct 68 to control the flow of cleaning solution, or alternatively, multiple duct 68 can be fluidly coupled to a single control valve to control flow of cleaning fluid to multiple air pulse tubes 62. Also, it is understood that the ancillary equipment for this cleaning in place system, such as pumps, valves, tanks, piping and the like, will be provided.

The simple inline cleaning system of the present invention is much less complex than the prior art cleaning systems using multiple low spray nozzles, bath systems, or moveable nozzles and filters currently employed in fluid bed processors.

It is understood that the cleaning apparatus and method of the present invention can be used on any filter, whether pleated, cylindrical, or planar. The filter cloth may be of any material, although stainless steel is economical for durability, economy, and the necessity to meet FDA standards for food, vitamin and pharmaceutical processes.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of cleaning a filter of a fluidized bed processor, comprising:
back pulsing a combination of air and liquid through the filter.

2. The method of claim 1 wherein the back pulsing cleans interstitial pores of the filter.

3. The method of claim 1 further comprising pre-washing the filter with cleaning solution prior to the back pulsing.

4. The method of claim 1 wherein the volume of the back pulse combination is in the range of 2-5 cu. ft. of air and 0.25-0.5 gallons of cleaning solution.

5. The method of claim 1 wherein the pressure of the back pulse air is in the range of 20-80 psi.

6. The method of claim 1 wherein the back pulse occurs while the filter is installed in the processor.

7. The method of claim 1 further comprising closing the ends of the filter during back pulsing.

8. The method of claim 7 further comprising opening one end of the filter after a predetermined regime of back pulse cycles to flush products out of the open end.

9. The method of claim 1 further comprising alternating back pulse cycle with rinse cycles for the filter.

10. The method of claim 1 wherein the back pulsing is from inside the filter to outside the filter.

11. The method of claim 10 wherein cleaning solution flows down the outside of the filter after passing through the filter.

12. The method of claim 1 further comprising spraying cleaning solution onto the inside of the filter after back pulsing to rinse the filter.

13. The method of claim 13 further comprising a final air rinse of the filter after the solution rinse to remove rinse solution.

14. The method of claim 1 wherein the back pulsing is in repetitive cycles.

15. The method of claim 15 wherein each cycle uses 0.08-0.16 gallons of cleaning solution.

16. The method of claim 15 wherein each cycle lasts 0.1-0.2 milliseconds.

17. An improved fluid bed processor having a filter and a pressurized back pulse air line with an outlet, the improvement comprising:
a cleaning liquid inlet in communication with the air line and upstream from the outlet for discharging a mixture of air and liquid to pass through the filter from inside to outside so as to clean the filter.

18. The improved fluid bed processor of claim 17 wherein the filter has a lower end which is normally closed during filter cleaning, and being openable to drain cleaning solution from inside the filter.

19. The improved fluid bed processor of claim 18 further comprising a cylinder with an extensible arm to move the lower end of the filter between open and closed positions.

20. The improved fluid bed processor of claim 17 wherein the filter includes a sidewall, a movable plate at the lower end, and a sealing member normally sealing the plate with the sidewall.
